(19) United States
(12) Patent Application Publication
(10) Pub. No.: US 2013/0127401 A1
(43) Pub. Date: May 23, 2013

(54) ENVIRONMENTALLY FRIENDLY PLUG-IN ADAPTER

(71) Applicant: Roger A. Fratti, Mohnton, PA (US)

(72) Inventor: Roger A. Fratti, Mohnton, PA (US)

(21) Appl. No.: 13/302,166

(22) Filed: Nov. 22, 2011

(51) Int. Cl. H02J 7/00; H01H 47/00

(52) U.S. Cl. 320/107; 307/130

(57) ABSTRACT

A plug-in adapter includes a transformer having a primary winding capable of being coupled to an AC power source and a secondary winding configured to provide an output charging voltage. The plug-in adapter also includes a voltage sensing connection configured to sense an external device voltage. Additionally, the plug-in adapter includes an adapter isolation switch coupled between the primary winding and the AC power source and configured to close by application of the external device voltage thereby providing the output charging voltage, wherein removal of the external device voltage opens the adapter isolation switch thereby substantially isolating the primary winding from the AC voltage source. In other aspects, a method of operating a plug-in adapter and a plug-in adapter system are provided.

### TECHNICAL FIELD

This application is directed, in general to battery charging and more specifically, to a plug-in adapter, a method of operating a plug-in adapter and a plug-in adapter system.

### BACKGROUND

Increasing concern focused on environmental issues related to electronic devices and systems is becoming a major design consideration for new equipment. Energy conservation is one of the more important environmental issues, especially in the area of “turned-off” power consumption, where environmentalists are recommending that even appliances such as computers or television sets, for example, be unplugged from their AC power source when not in use in order to conserve electrical energy. Plug-in adapters (colloquially referred to as “wall warts”) have proliferated in use and often remain connected to an AC power source even when their rechargeable battery-powered user devices or systems are unplugged from an output of the plug-in adapter. For this condition, the plug-in adapter's primary transformer winding remains connected to the AC power source thereby wasting electrical energy due to its core and eddy current losses. Improvements in this area would prove beneficial to the art.

### SUMMARY

Embodiments of the present disclosure provide a plug-in adapter, a method of operating a plug-in adapter and a plug-in adapter system.

In one embodiment, the plug-in adapter includes a transformer having a primary winding capable of being coupled to an AC power source and a secondary winding configured to provide an output charging voltage. The plug-in adapter also includes a voltage sensing connection configured to sense an external device voltage. Additionally, the plug-in adapter includes an adapter isolation switch coupled between the primary winding and the AC power source and configured to close by application of the external device voltage thereby providing the output charging voltage, wherein removal of the external device voltage opens the adapter isolation switch thereby substantially isolating the primary winding from the AC voltage source.

In another aspect, the method of operating a plug-in adapter includes providing a capability of supplying an output charging voltage with a secondary winding of a transformer having a primary winding coupleable to an AC power source. The method of operating a plug-in adapter also includes sensing an external device voltage to close an adapter isolation switch located between the primary winding and the AC power source thereby supplying the output charging voltage. The method of operating a plug-in adapter further includes removing the external device voltage to open the adapter isolation switch thereby substantially isolating the primary winding from the AC voltage source.

In yet another aspect, the plug-in adapter system includes a user device having a rechargeable battery coupled to a battery charging circuit and a connector assembly that provides coupling between one of the rechargeable battery and the battery charging circuit and an output charging voltage. The plug-in adapter system also includes a plug-in adapter, coupled to the connector assembly, with a transformer having a primary winding capable of being coupled to an AC power source and a secondary winding configured to provide the output charging voltage. The plug-in adapter also has a voltage sensing connection that senses an external device voltage from the user device. The plug-in adapter further has an adapter isolation switch coupled between the primary winding and the AC power source that closes by application of the external device voltage thereby providing the output charging voltage, wherein removal of the external device voltage opens the adapter isolation switch thereby substantially isolating the primary winding from the AC voltage source.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

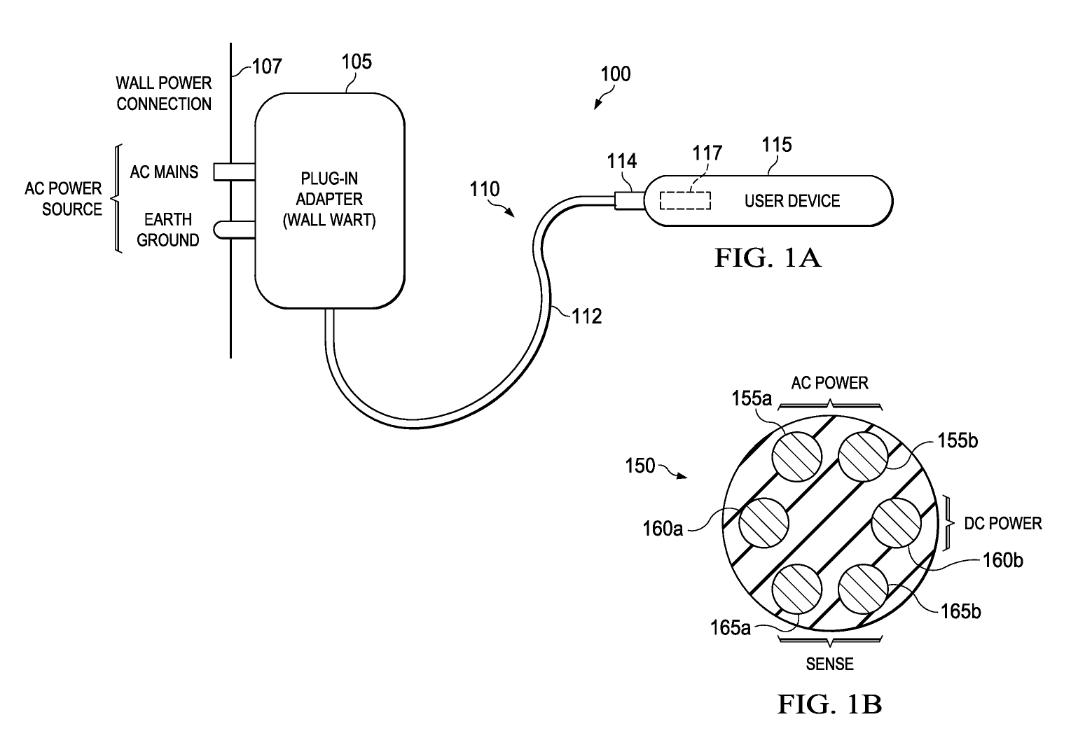

FIG. 1A illustrates a diagram of an embodiment of a plug-in adapter system constructed according to the principles of the present disclosure;

FIG. 1B illustrates a sectioned view of a connector assembly cable as may be employed in the plug-in adapter system of FIG. 1A;

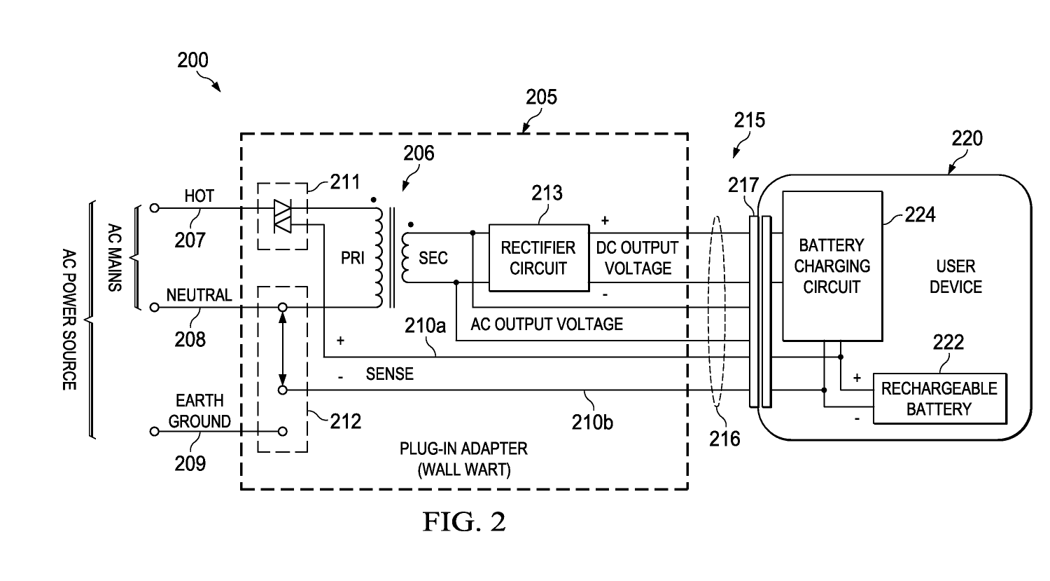

FIG. 2 illustrates a schematic representation of an embodiment of a plug-in adapter system constructed according to the principles of the present disclosure; and

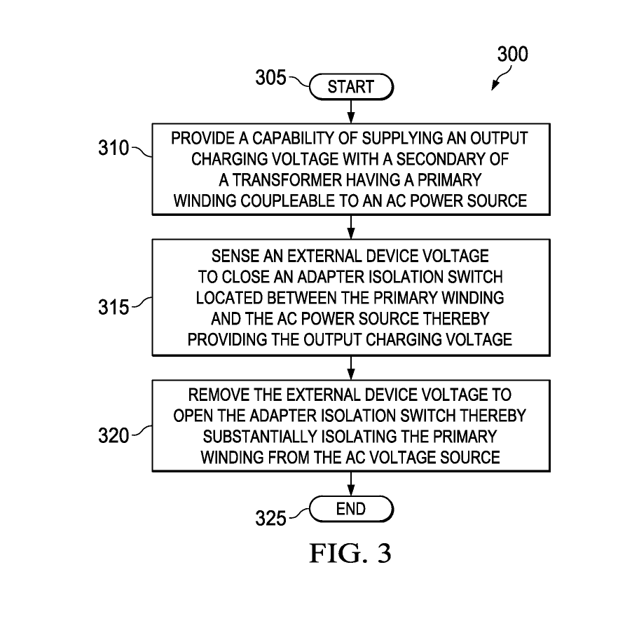

FIG. 3 illustrates a flow diagram of an embodiment of a method of operating a plug-in adapter carried out according to the principles of the present disclosure.

### DETAILED DESCRIPTION

FIG. 1A illustrates a diagram of an embodiment of a plug-in adapter system, generally designated 100, constructed according to the principles of the present disclosure. In the illustrated embodiment, the plug-in adapter system 100 includes a plug-in adaptor 105 connected to a wall power connection 107 that provides an AC power source having connections for AC mains and Earth ground, as shown. The plug-in adapter system 100 also includes a connector assembly 110 connected to the plug-in adaptor 105 having a connector assembly cable 112 and an adapter connector 114. The plug-in adapter system 100 further includes a user device 115 having a rechargeable battery pack 117 connected to the adapter connector 114.

The rechargeable battery pack 117 includes a rechargeable battery coupled to a battery charging circuit. The connector assembly 110 provides coupling between the rechargeable battery or the battery charging circuit and an output charging voltage supplied by the plug-in adaptor 105. The plug-in adapter 105 includes a transformer that has a primary winding capable of being coupled to the AC power source and a secondary winding configured to provide the output charging voltage to the adapter connector 114 through the connector assembly cable 112. The plug-in adapter 105 also includes a voltage sensing connection through the connector assembly cable 112 and adapter connector 114 that senses an external device voltage from the user device 115.

The plug-in adaptor 105 further includes an adapter isolation switch coupled between the primary winding and the AC power source that closes by application of the external device voltage thereby providing the output charging voltage to the adapter connector 114. Disconnecting the user device 115 from the adapter connector 114 removes the external device voltage and opens the adapter isolation switch thereby substantially isolating the primary winding from the AC voltage source.

FIG. 1B illustrates a sectioned view of a connector assembly cable, generally designated 150, as may be employed in the plug-in adapter system 100 of FIG. 1A and constructed according to the principles of the present disclosure. In the illustrated embodiment of FIG. 1B, the conductor assembly cable 150 includes three pairs of conductors: AC power conductors 155a, 155b, DC power conductors 160a, 160b and voltage sensing conductors 165a, 165b. Other embodiments of a connector cable assembly may include a subset of these conductors depending on user device requirements, such as the AC power conductors 155a, 155b and the voltage sensing conductors 165a, 165b, for example. Alternately, only the DC power conductors 160a, 160b and one of the voltage sensing conductors 165a, 165b may be included.

FIG. 2 illustrates a schematic representation of an embodiment of a plug-in adapter system, generally designated 200, constructed according to the principles of the present disclosure. The illustrated embodiment of the plug-in adapter system 200 includes a plug-in adapter 205, a connector assembly 215 and a user device 220.

The plug-in adapter 205 includes a transformer 206 that has one side of a primary winding PRI connectable to a Hot side 207 of an AC mains of an AC power source and the other side connected to a Neutral side 208 of the AC Mains. The transformer 206 also includes a secondary winding SEC that provides an output charging voltage. The output charging voltage may be a DC output voltage provided by a rectifier 213 connected to the secondary winding SEC or an AC output voltage provided by the secondary winding SEC itself.

In the illustrated embodiment, the connector assembly 215 includes a connector assembly cable 216 and an adapter connector 217 that provide connection between the DC output voltage and a battery charging circuit 224 of the user device 220. In the illustrated embodiment, the AC output voltage is not employed, as shown. The connector assembly 215 also includes a voltage sensing connection 210a, 210b that senses an external device voltage from a rechargeable battery 222 or the battery charging circuit 224 of the user device 220.

An adapter isolation switch 211 of the plug-in adapter 205 is connected between the primary winding PRI and the Hot side 207 of the AC mains, as shown. A TRIAC is employed as the adapter isolation switch 211 and it is closed, causing the TRIAC to conduct, through the positive voltage side 210a of the voltage sensing connection 210a, 210b by the external device voltage to enable the output charging voltage.

In this embodiment, the negative voltage side 210b of the voltage sensing connection 210a, 210b is connected to the Neutral side 208 of the AC Mains through a grounding selection switch 212. This provides a positive activation voltage (i.e., a positive external device voltage) to the TRIAC adapter isolation switch 211 thereby enhancing its activation sensitivity for a positive cycle of an AC input voltage supplied by the Hot side 207. The TRIAC adapter isolation switch 211 continues to conduct for both positive and negative cycles of the AC input voltage as long as the positive activation voltage remains on the positive voltage side 210a.

Other embodiments of the present disclosure may employ the grounding selection switch 212 to connect the negative voltage side 210b to the Earth ground 209. If this connection is employed in the plug-in adapter 205 and the user device 220, the connector assembly cable 216 may contain only the positive voltage side 210a to activate the TRIAC adapter isolation switch 211.

When charging of the rechargeable battery 222 is complete, the user device 220 is removed from the connector assembly 215 thereby removing the external device voltage and opening the TRIAC adapter isolation switch 211 causing it to stop conducting. This action substantially isolates the primary winding PRI from the AC voltage source thereby greatly diminishing leakage power associated with the plug-in adapter 205.

FIG. 3 illustrates a flow diagram of an embodiment of a method of operating a plug-in adapter, generally designated 300, carried out according to the principles of the present disclosure. The method 300 starts in a step 305, and a capability of supplying an output charging voltage is provided with a secondary winding of a transformer having a primary winding coupleable to an AC power source, in a step 310. Then, in a step 315, an external device voltage is sensed to close an adapter isolation switch located between the primary winding and the AC power source thereby supplying the output charging voltage. The external device voltage is removed to open the adapter isolation switch thereby substantially isolating the primary winding from the AC voltage source, in a step 320.

In one embodiment, the output charging voltage is one of a DC charging voltage and an AC charging voltage. In another embodiment, the external device voltage is supplied by one of a rechargeable battery and a battery charging circuit in a user device wherein the battery charging circuit is at least a portion of an integrated circuit within the user device. In yet another embodiment, the adapter isolation switch is a bidirectional triode thyristor (TRIAC).

In still another embodiment, one of a Neutral connection and an Earth ground connection of the AC power source is employed in sensing the external device voltage. In this case, a grounding selection switch may select one of the neutral connection and the earth ground connection. The method 300 ends in a step 325.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A plug-in adapter, comprising:
a transformer having a primary winding capable of being coupled to an AC power source and a secondary winding configured to provide an output charging voltage;
a voltage sensing connection configured to sense an external device voltage; and
an adapter isolation switch coupled between the primary winding and the AC power source and configured to close by application of the external device voltage thereby providing the output charging voltage, wherein removal of the external device voltage opens the adapter isolation switch thereby substantially isolating the primary winding from the AC voltage source.

2. The plug-in adapter as recited in claim 1 wherein the output charging voltage is one of a DC charging voltage and an AC charging voltage.

3. The plug-in adapter as recited in claim 1 wherein one of a neutral connection and an earth ground connection of the AC power source is employed in sensing the external device voltage.

4. The plug-in adapter as recited in claim 3 wherein a grounding selection switch selects one of the neutral connection and the earth ground connection.

5. The plug-in adapter as recited in claim 1 wherein the external device voltage is supplied by one of a rechargeable battery and a battery charging circuit in a user device.

6. The plug-in adapter as recited in claim 5 wherein the battery charging circuit is at least a portion of an integrated circuit within the user device.

7. The plug-in adapter as recited in claim 1 wherein the adapter isolation switch is a bidirectional triode thyristor (TRIAC).

8. A method of operating a plug-in adapter, comprising:
providing a capability of supplying an output charging voltage with a secondary winding of a transformer having a primary winding coupleable to an AC power source;
sensing an external device voltage to close an adapter isolation switch located between the primary winding and the AC power source thereby supplying the output charging voltage; and
removing the external device voltage to open the adapter isolation switch thereby substantially isolating the primary winding from the AC voltage source.

9. The method as recited in claim 8 wherein the output charging voltage is one of a DC charging voltage and an AC charging voltage.

10. The method as recited in claim 8 wherein one of a neutral connection and an earth ground connection of the AC power source is employed in sensing the external device voltage.

11. The method as recited in claim 10 wherein a grounding selection switch selects one of the neutral connection and the earth ground connection.

12. The method as recited in claim 8 wherein the external device voltage is supplied by one of a rechargeable battery and a battery charging circuit in a user device.

13. The method as recited in claim 12 wherein the battery charging circuit is at least a portion of an integrated circuit within the user device.

14. The method as recited in claim 8 wherein the adapter isolation switch is a bidirectional triode thyristor (TRIAC).

15. A plug-in adapter system, comprising:
a user device having a rechargeable battery coupled to a battery charging circuit; and
a connector assembly that provides coupling between one of the rechargeable battery and the battery charging circuit and an output charging voltage; and
a plug-in adapter coupled to the connector assembly, including:
a transformer having a primary winding capable of being coupled to an AC power source and a secondary winding configured to provide the output charging voltage,
a voltage sensing connection that senses an external device voltage from the user device, and
an adapter isolation switch coupled between the primary winding and the AC power source that closes by application of the external device voltage thereby providing the output charging voltage, wherein removal of the external device voltage opens the adapter isolation switch thereby substantially isolating the primary winding from the AC voltage source.

16. The system as recited in claim 15 wherein the output charging voltage is one of a DC charging voltage and an AC charging voltage.

17. The system as recited in claim 15 wherein one of a neutral connection and an earth ground connection of the AC power source is employed in sensing the external device voltage.

18. The system as recited in claim 17 wherein a grounding selection switch selects one of the neutral connection and the earth ground connection.

19. The system as recited in claim 15 wherein the external device voltage is supplied by one of a rechargeable battery and a battery charging circuit in a user device.

20. The plug-in adapter as recited in claim 15 wherein the adapter isolation switch is a bidirectional triode thyristor (TRIAC).
